(19) United States
(12) Patent Application Publication
(10) Pub. No.: US 2026/0327085 A1
(43) Pub. Date: Oct. 22, 2026

(54) SEPARATION AND RECOVERY OF MINERALS FROM INTERFACIAL EVAPORATION DEVICES

(71) Applicant: Saudi Arabian Oil Company, Dhahran (SA)

(72) Inventors: Sarah Almahfoodh, Anak (SA); Raed Makeen, Dammam (SA); Faiz Almudaraa, Dammam (SA); Bandar Fadhel, Dhahran (SA); Omprakash Pal, Dhahran (SA); Omar Bashir Wani, Dhahran (SA)

(73) Assignee: Saudi Arabian Oil Company, Dhahran (SA)

(21) Appl. No.: 19/724,083

(22) Filed: Jun. 29, 2026

Related U.S. Application Data
(63) Continuation-in-part of application No. 19/087,993, filed on Mar. 24, 2025.

(51) Int. Cl. C01D 3/06; B01D 1/00; C01F 11/18; C01F 11/46

(52) U.S. Cl. CPC C01D 3/06; B01D 1/0005; B01D 1/0035; C01F 11/18; C01F 11/46

(57) ABSTRACT

Methods to separate and recover minerals from interfacial evaporation devices includes deploying an interfacial evaporation device on a surface of a body of water. The interfacial evaporation device draws water to a surface of the interfacial evaporation device. The drawn water is evaporated by solar energy depositing a residue comprising minerals on the surface of the interfacial evaporation device. The residue is collected from the surface of the interfacial evaporation device. The collected residue is processed to separate the minerals.

### CROSS-REFERENCE TO RELATED APPLICATIONS

This application is a continuation-in-part application of and claims priority to U.S. application Ser. No. 19/087,993 entitled “Interfacial Evaporation Device For Evaporation Ponds” and filed on Mar. 24, 2025, the entire contents of which are incorporated herein by reference.

### TECHNICAL FIELD

This disclosure relates to processing wastewater in evaporation ponds and to recovering minerals obtained by such processing.

### BACKGROUND

Evaporation ponds are large, shallow pools that utilize sunlight and wind for water evaporation. Evaporation ponds are used across various industries due to their ease of construction and operation. For example, in oil and mining operations, an evaporation pond can concentrate contaminated wastewater, thereby reducing its volume for treatment. In another example, evaporation ponds are used in agriculture to manage water drainage, thereby preventing salinization of freshwater sources. Evaporation ponds can also be utilized in desalination as brine management tools for in-land desalination plants and in salt production and mineral recovery.

Evaporation ponds rely on atmospheric conditions such as humidity, sunlight, wind, and temperature, thereby making the evaporation and concentration processes slow in areas with low wind or sunlight. In addition, evaporation ponds often require large surface area for efficient operation. In addition, contaminated water, such as industrial or oily waters, include floater particles and substances. Such particles and substances form a layer over the water, thereby preventing sunlight from effectively heating the water. The capacity of an evaporation pond is limited, thereby increasing vulnerability to overflow due to operational or seasonal variations.

### SUMMARY

This disclosure describes technologies relating to advanced designs of interfacial evaporation devices for evaporation ponds. This disclosure also describes technologies relating to the separation and recovery of minerals from interfacial evaporation devices.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1 is a schematic diagram of an evaporation pond deploying an interfacial evaporation device.

FIG. 2 is a schematic diagram of the interfacial evaporation device of FIG. 1 with a micro-patterned surface.

FIG. 3 is a schematic diagram of the interfacial evaporation device of FIG. 1 with a membrane coating.

FIG. 4 is a schematic diagram of an evaporation pond deploying another implementation of an interfacial evaporation device.

FIG. 5 is a flowchart of an example of a process of using an interfacial evaporation device in an evaporation pond.

FIGS. 6A and 6B are schematic diagrams of an example of a first implementation of a wick subassembly.

FIGS. 6B and 6C are schematic diagrams of examples of respective interfacial evaporation devices implementing the wick subassembly of FIG. 6A.

FIG. 6D shows the interfacial evaporation device in which the membrane 102 is replaced by the modified membrane.

FIG. 7A is a schematic diagram of an example of a second implementation of a wick subassembly.

FIGS. 7B, 7C and 7D are schematic diagrams of examples of respective interfacial evaporation devices implementing the wick subassembly of FIG. 7A.

FIGS. 8A-8E are schematic diagrams of examples of a third implementation of a wick subassembly.

FIGS. 9A-9E are schematic diagrams of examples of a third implementation of a wick subassembly.

FIG. 10 is a flowchart of an example of a process of recovering minerals.

### DETAILED DESCRIPTION

This disclosure describes an interfacial evaporation device for enhancing evaporation efficiency of evaporation ponds. The device integrates material and engineering modifications into a single device. The device includes a floating hydrophobic phase, a wick, and a membrane. The membrane rests on top of the floating hydrophobic phase, and the wick goes through the floating hydrophobic phase to connect to the membrane. The membrane provides the evaporation surface of the device. The floating hydrophobic phase provides flotation and thermal insulation, which focuses heat on the membrane. The wick delivers water from the body of water to the membrane. The membrane and wick can be hydrophilic.

This disclosure also describes designs of interfacial evaporation devices that include a wick subassembly having different designs. Each design is made of two different materials—a first material that is hydrophilic and oleophobic, and a second material that is hydrophobic. Each wick subassembly can be used in the device in place of or in addition to a single wick. As described below, each wick subassembly enhances the performance of the interfacial evaporation device.

This disclosure further describes the collection of residue left behind on the surface of the interfacial evaporation devices after such evaporation and the processing of the residue to extract valuable minerals. As described below, such minerals can be used in well operations, e.g., as drilling additives.

For example, sodium chloride recovered in both filtrate and solid form after evaporation/drying at 180° C. can serve as a valuable additive in completion and drilling fluids. Sodium chloride can also be used to increase the density of water-based drilling fluids, providing effective hydrostatic control. Sodium chloride additionally serves as a shale inhibitor in oilfield operations and can help to stabilize clay-rich formations and prevent swelling or dispersion of shale. Clean sodium chloride solution can be employed as a completion or workover fluid to minimize formation damage during interventions in the production zone.

In another example, solid residue, enriched with calcium carbonate, can be utilized in the manufacture of cement, such as Portland cement. Calcium carbonate serves as a primary raw material in cement production and can be employed during the calcination process in a kiln. Under high-temperature conditions, calcium carbonate decomposes into calcium oxide and carbon dioxide. In certain cases, calcium sulfate within the residue may also de-compose into calcium oxide and sulfur dioxide. The resulting calcium oxide can subsequently react with silicates, aluminates and ferrites to form complex cementitious compounds, which contribute to the strength and durability of the final cement product.

In a further example, the solid residue, which includes calcium carbonate, can be employed as an additive in cement formulations. The residue can be used to enhance the performance characteristics of cement, particularly in oil well cementing and other construction applications. The residue can influence the thickening time of the cement slurry, improve compressive strength development and contribute to early hydration reactions. The particle size of the solid residue can be controlled or adjusted to tailor specific formulation properties, such as rheology, setting time, and mechanical performance. Such adaptability allows for optimized cement compositions suitable for a range of industrial and structural applications.

Additional examples of recoverable salts include calcium chloride (CaCl), potassium chloride (KCl), calcium bicarbonate (Ca(HCO₃)₂) or potassium carbonate (NaHCO₃) depending on pH of water. Examples can further include metals such as lithium, manganese, cobalt, nickel or combinations of them.

The device can be implemented in bodies of water to improve evaporation from such bodies of water and provide one or more of the following benefits: reducing pond foot-print requirements for new ponds, improving evaporation for ponds with a wide range of water compositions, free of requiring moving parts and input of energy to improve evaporation, and recovering water and minerals from ponds. In some implementations, the membrane can have a micro-patterned surface to increase surface area for further increasing evaporation rate. The device can also improve concentration of different wastewater streams in the evaporation pond, such as produced water, sour recovery unit wastewater, CPI outlet, to name a few.

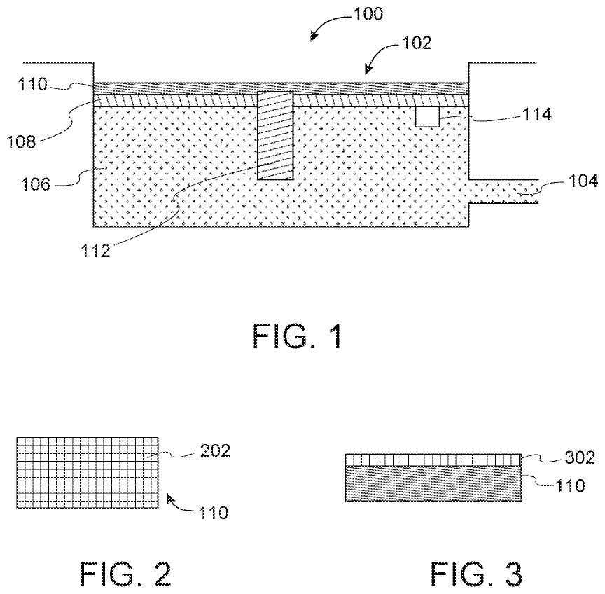

FIG. 1 is a schematic diagram of an evaporation pond 100 deploying an interfacial evaporation device 102. An evaporation pond 100 is a shallow, man-made pit in the surface of the Earth to receive water. In this disclosure, certain implementations of evaporation ponds that receive wastewater from wells, for example, hydrocarbon producing wells, are described. However, the interfacial evaporation device described in this disclosure can be deployed in evaporation ponds built to hold water from other sources as well. Such sources can include, for example, oceans, seas, lakes, rivers, wastewater from processing plants (such as Gas Oil Separation Plants), produced water, industrial water, brine or textile water. In the schematic diagram shown in FIG. 1, the evaporation pond 100 receives wastewater through an inlet 104 connected to a producing well (not shown). The inlet 104 can be above or below the surface of the Earth. In implementations in which the inlet is above the surface of the Earth, the interfacial evaporation device 102 may not cover the entire surface of the evaporation pond 100, but instead may cover a portion (e.g., most of) the surface with the inlet to allow the water to be received within the evaporation pond 100. Water 106 flowed through the inlet fills the evaporation pond 100.

The interfacial evaporation device 102 includes a member 108 that can float on a surface of the water 106 in the evaporation pond 100. In some implementations, the member 108 can be a single structure that has a surface area that is large enough to cover substantially an entire surface of the water 106 in the evaporation pond 100. In some implementations, the interfacial evaporation device 102 can include multiple members, each having a surface area to cover a portion of the surface of the water 106. Multiple such members together can be deployed to cover the entire surface of the water 106. The member 108 is hydrophobic and can repel water away from itself. By doing so, the member 108 ensures that the member 108 and any other structure attached to the member 108 remains at the surface of the water 106. In addition, the member 108 can be made of or can be covered by an insulating material that can focus on retrieval of solar energy onto the membrane 108 while preventing a majority of the solar energy from being transferred through to the body of water below.

The interfacial evaporation device 102 includes a membrane 110 disposed on a surface of the member 108. The membrane 110 defines an evaporation surface of the interfacial evaporation device 102 for receiving solar energy. In some implementations, the membrane 110 is planar with a surface area equal to that of the member 108. When the membrane 110 is disposed on a surface of the member 108, the membrane 110 can cover an entirety of the surface of the member 108. When deployed in an evaporation pond 100, the member 108 is in immediate contact with the water 106. The membrane 110 resides above the member 108 such that the member 108 is between the membrane 110 and the surface of the water 106. The membrane 110 is hydrophilic and attracts water to itself. In some implementations, the membrane 110 is one of a Janus membrane, an omniphobic membrane or an oleophobic membrane. For example, hydrophilic membranes are suitable for aqueous phases. In ponds in which oily/organic phase is present, oleo-or omni-phobic membranes can present longer lifetime and performance stability.

In some implementations, the membrane 110 includes a micro-patterned surface. FIG. 2 is a schematic diagram of the interfacial evaporation device of FIG. 1 with the micro-patterned surface 202. The micro-patterned surface (such as the surface 202) increases a surface area for evaporation. The micro-patterned surface is arranged on the membrane 110 such that the surface is exposed to the sun. The micro-patterned surface can be formed by depositing photothermal materials on the surface, e.g., by coating, cross-linking or vacuum filtration.

The dimensions of the pattern can be in the micrometer range (e.g., between 1 micrometer and 100 micrometers). The patterns can be formed during coating process. For planar geometry, for example, just after coating (e.g., slot-die coating), the coated membrane can pass through a press roller before drying. The roller surface can have a mesh type pattern on the surface to press the undried membrane surface and then dry. The surface area can be high for enhanced evaporation. For example, the evaporation rate can be expressed as area-normalized flow rate (i.e., flux). The surface area can be sufficient to result in an evaporation rate having a flux greater than 0.5 kg/m²/h, which is the highest flux achievable in conventional evaporation ponds.

In some implementations, the membrane 110 has a coating on a surface exposed to the sun. FIG. 3 is a schematic diagram of the interfacial evaporation device of FIG. 1 with a membrane coating 302. The coating (such as the coating 302) can include a photothermal material that can absorb sunlight and increase a temperature of the membrane 110. For example, the coating can include carbon (e.g., graphene, graphite, carbon black), a metal or a metal oxide (e.g., gold, silver, iron), a polymer (e.g., polypyrrole, polydopamine, polyaniline, poly(ethylenedioxythiophene): polystyrene (PEDOT: PSS) or combinations of them.

In some implementations, the membrane can be coated through slot-die coating, particularly for planar geometries. Spin coating is another example of a simple, low-cost method to apply coating layer on top of a flat surface. In spin coating, the substrate size can be limited depending on the spin coater size. Tubular geometry membranes can be coated by phase inversion spinning process or dip coating. In phase inversion spinning process, coating material and polymeric material are mixed to make a homogeneous solution using solvent or heat. The solution is then extruded through a spinneret to induce phase separation followed by membrane solidification. In dip coating, the substrate is immersed into a solution containing material and withdrawn at constant speed. The coating speed, concentration of coating solution and ambient temperature determine the coating thickness. In some implementations, the coating can include an ultraviolet resistant material to protect the membrane 110 against degradation from sunlight. The ultraviolet resistant material can be a separate coating on top of the photothermal coating or the UV resistant material can be mixed in with the photothermal material.

In some implementations, the coating can include a hydrophobic material. The hydrophobic material can be used if salt crystallization is a harmful byproduct. For example, if the device 102 is used to enhance evaporation without collection of precipitated salt, a hydrophobic layer would prevent salt from accumulating over the surface while water vapor can evaporate. The hydrophobic coating can either be added separately (below or on top of the thermal layer) or mixed with the photothermal particles as one-layer during fabrication.

Returning to FIG. 1, the interfacial evaporation device 102 includes a wick 112. An end of the wick 112 is attached to the membrane 110. The body of the wick 112 passes through the member 108 and extends into the water 106 such that an opposite end of the wick 112 resides close to the bottom of the evaporation pond 100. The wick 112 is attached to the member 108. In some implementations, the end of the wick 112 contacts the floating member 108 such that either the floating member 108 is above the wick 112 or the floating member 108 and the contacting end of the wick 112 and the floating member 108 are coplanar. In some implementations, the end of the wick 112 can protrude above the floating member 108. In some implementations, the wick 112, membrane 110 and the floating member 108 can be connected through threaded strings. The wick 112 can be made of a hydrophilic material to absorb water to itself.

In operation, the wick 112 contacts the water 106 in the evaporation pond 100. Due to its hydrophilic nature, the wick 112 draws the water 106 towards itself and direct the drawn water to the membrane 110 through the member 108. The membrane 110 absorbs the water from the wick 112. The absorbed water spreads to the exposed surface area of the membrane 110. As described above, the membrane 110 also absorbs sunlight, converts the sunlight into thermal energy, and uses the thermal energy to evaporate the water absorbed by the membrane 110. The evaporated water leaves behind contaminants carried by the water on the surface of the membrane 110. In this manner, the contaminants are concentrated by the interfacial evaporation device 102. In some implementations, one or more sensors 114 can be deployed as part of (e.g., attached to) the interfacial evaporation device 102. The sensors 114 can monitor a water level in the pond. Alternatively or in addition, the sensors 114 can monitor an evaporation level of the interfacial evaporation device 102. The sensors 114 can transmit monitored values to a controller (not shown) from which the monitored values can be retrieved.

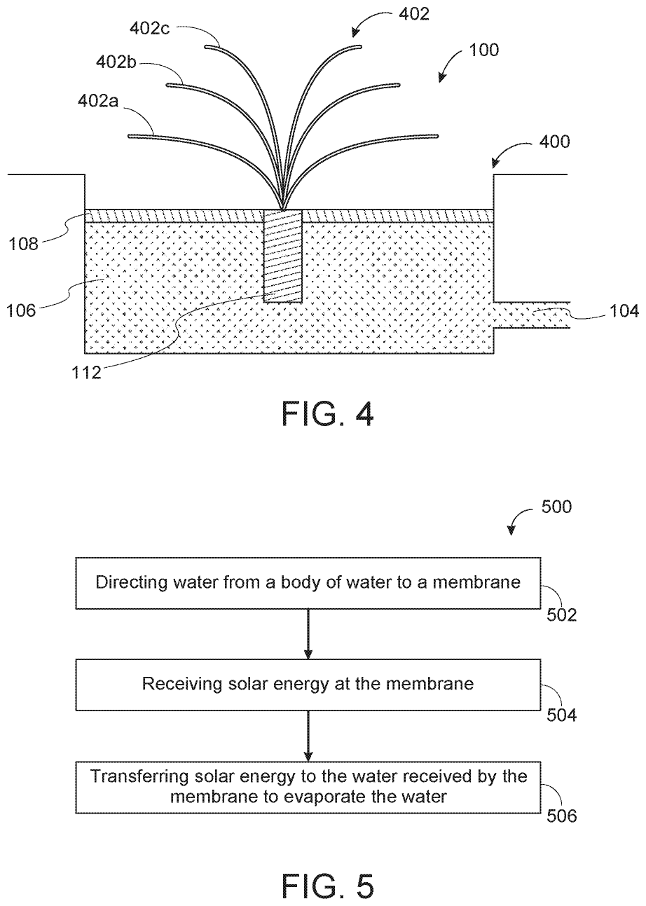

FIG. 4 is a schematic diagram of an evaporation pond deploying another implementation of an interfacial evaporation device 400. Like the interfacial evaporation device 102, the interfacial evaporation device 400 can also be deployed in the evaporation pond 100. The interfacial evaporation device 400 can include the member 108 and the wick 112. In place of the membrane 110 (FIG. 1), the interfacial evaporation device 400 can include a modified membrane 402. The modified membrane 402 includes multiple tubes (e.g., tubes 402a, 402b, 402c), each of which has the same properties of the membrane 110 (FIG. 1). One end of each of the tubes is connected to an end of the wick 112. The other end of each of the tubes extends away from the surface of the member 108. Each tube can be porous or a composite of materials. Each tube can include dense and hollow fiber or threads that can be made of polymeric materials, plastics, fabrics, paper or a combination of them. A hollow fiber can be an elongate tube that is hollow in the middle. A thread can be a solid elongate tube without an internal hollow portion. The tube can also be made of porous inorganic membranes such as ceramics or metal membranes. Each tube has a length that is vertical relative to the member 108 and a strength to limit bending due to wind. The length and diameter of the tube is also selected such that a surface area of a shadow of the tube at different times of the day on the member 108 is minimized. In some implementations, instead of an elongate tubular design, the modified membrane 402 can include multiple sheets (e.g., hollow or solid, having planar geometry with polygonal cross-section such as triangular, rectangular, etc.) having similar properties as each of the tubes 402a, 402b, 402c.

In the schematic shown in FIG. 1, a single membrane 110 that covers the entire member 108 is shown and described. A single wick 112 passes through the member 108 to connect to the single membrane 112. In contrast, in the schematic shown in FIG. 4, the single wick 112 passes through the member 108 to connect to ends of multiple membranes. Other constructions are also possible. For example, in place of a single wick, multiple wicks can be deployed at multiple locations along the surface of the member 108. The member 108 can define multiple openings through which respective, multiple wicks can be passed. The ends of each of the multiple wicks can be attached to the single membrane 112. In another design, all of the multiple wicks can pass through the same opening in the member 108 to attach to the membrane 112. In a further design, all of the multiple wicks can pass through the same opening in the member 108 to attach to ends of multiple tubular membranes such as those shown in FIG. 4.

FIG. 5 is a flowchart of an example of a process 500 of using an interfacial evaporation device in an evaporation pond. At 502, water from a body of water (e.g., an evaporation pond) is directed by a wick to a membrane disposed on a non-submerged surface of a hydrophobic member floating at a surface of the body of water. The wick extends through the hydrophobic member and connects to the membrane. At 504, solar energy is received by the membrane at an evaporation surface of the membrane. At 506, at least a portion of the received solar energy is transferred to the water directed by the wick from the body of water to the membrane. The solar energy evaporates at least a portion of the water. In doing so, contaminants in the water can be concentrated on the membrane surface.

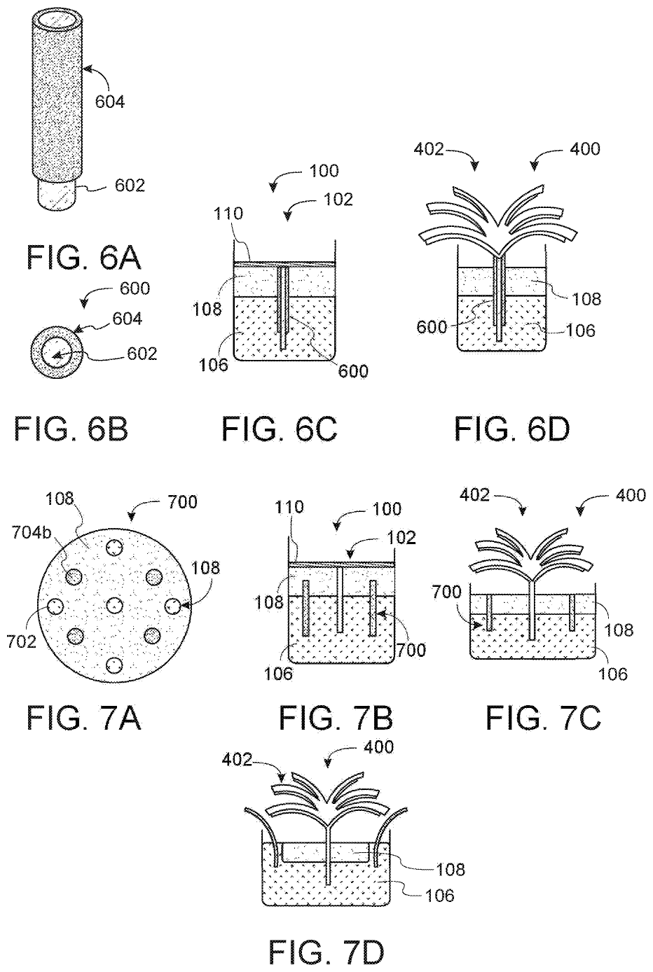

In some implementations, the wick 122 in FIGS. 1 and 4 can be a unitary body made of a single material. In some implementations, the wick 122 can be replaced by or supplemented with a wick subassembly that is made of two materials. Such implementations are described with reference to FIGS. 6A-9F.

FIGS. 6A and 6B are schematic diagrams of an example of a first implementation of a wick subassembly 600. FIG. 6A is a schematic front view of the wick subassembly 600. FIG. 6B is a schematic cross-sectional view of the wick subassembly 600. The wick subassembly 600 is constructed with a solid tube inner core 602 that is surrounded by a fiber outer shell 604. The inner core 602 is composed of a first material that is configured to enhance water evaporation. For example, the first material possesses hydrophilic/oleophobic properties, allowing the inner core 602 to effectively absorb and transport water while repelling oil contaminants. Encasing this, the tube outer shell 604 is made from a second material. The second material is configured to prevent water loss from the inner core 602. For example, the second material is hydrophobic and nonporous, allowing the hollow tube outer shell 604 to provide a barrier that prevents water from escaping while also blocking the ingress of unwanted substances. The tube outer shell 604 additionally enhances durability, provides additional protection against environmental contaminants, and further minimizes the risk of oil accumulation, ensuring optimal evaporation efficiency. This dual-material configuration ensures selective water transport and enhanced durability for the interfacial evaporation device.

The inner core 602 of the wick subassembly can have a cylindrical cross-section, or it can be shaped with other cross-sectional profiles such as rectangular, square, triangular, or hexagonal. These alternative shapes may be selected depending on the desired fluid transport characteristics or mechanical stability. Correspondingly, the hollow tube outer shell 604 is designed with an inner cross-sectional shape that matches the cross-sectional shape of the inner core 602, ensuring a snug fit and effective encapsulation.

The hollow tube outer shell 604 can be configured to cover the entire length of the inner core 602, providing continuous protection and selective water transport along the whole wick. Alternatively, it may cover only a portion of the inner core's length. For example, the bottom portion of the inner core 602 can remain uncovered by the hollow tube outer shell 604 so that the exposed bottom directly contacts the water in the evaporation pond, while the water does not come into contact with the hollow tube outer shell 604. This design allows for efficient water uptake at the submerged end while maintaining the protective and selective transport benefits along the remainder of the wick.

FIGS. 6B and 6C are schematic diagrams of examples of respective interfacial evaporation devices 100 (FIGS. 6B), 400 (FIG. 6C) implementing the wick subassembly of FIG. 6A. FIG. 6C shows the interfacial evaporation device 102 including the member 108 that can float on a surface of the water 106 in the evaporation pond 100. The interfacial evaporation device 102 includes the membrane 110 disposed on the surface of the member 108.

In place of (or in addition to) the wick 112 (FIG. 1), the interfacial evaporation device 102 includes the wick subassembly 600 (FIGS. 6A, 6B). An end of the wick sub-assembly 600 is attached to the membrane 110. The body of the wick subassembly 600 passes through the member 108 and extends into the water 106 such that an opposite end of the wick subassembly 600 resides close to the bottom of the evaporation pond 100. For example, the portion of the wick subassembly 600 in which the inner core 602 is uncovered by the hollow tube outer shell 604 can form the bottom end of the wick subassembly 600 that is dipped into the evaporation pond 100. The other end of the wick subassembly 600, where the inner core 602 is fully covered by the hollow outer tube core 604 can extend through the member 108 and be directly connected to the membrane 110. In some implementations, the end of the wick subassembly 600 contacts the floating member 108 such that either the floating member 108 is above the wick subassembly 600 or the floating member 108 and the contacting end of the wick subassembly 600 and the floating member 108 are coplanar. In some implementations, the end of the wick subassembly 600 can protrude above the floating member 108. FIG. 6D shows the interfacial evaporation device 400 in which the membrane 102 is replaced by the modified membrane 402, which features a larger surface area exposed to sunlight. This enhancement enables greater photothermal conversion efficiency by utilizing the expanded surface area. The remainder of the construction of the interfacial evaporation device 400, specifically the installation and deployment of the wick subassembly 600, is substantially identical to that of the interfacial evaporation device 102.

In operation, the wick subassembly 600 contacts the water 106 in the evaporation pond schematically shown in FIG. 6C or 6D. A circumferential surface of the inner core 602 is exposed to increase direct contact between the water in the evaporation pond and the wick subassembly 600. Due to the hydrophilic nature of the inner core 602, the wick sub-assembly 600 draws the water 106 towards itself and directs the drawn water to the membrane 110 (FIG. 6C) or the modified membrane 402 (FIG. 6D) through the member 108. At the same time, the hydrophobic nature of the hollow outer tube core 604 prevents water from escaping the inner core 602. The water retention function of the hollow outer tube core 604 is further assisted by the nonporous nature of the material with which the hollow outer tube core 604 is made. The membrane 110 or the modified membrane 402 absorbs the water from the wick subassembly 600. The absorbed water spreads to the exposed surface area of the membrane 110 or the modified membrane 402. As described above, the membrane 110 or the modified membrane 402 also absorbs sunlight, converts the sunlight into thermal energy, and uses the thermal energy to evaporate the water absorbed by the membrane 110 or the modified membrane 402, respectively. The evaporated water leaves behind contaminants carried by the water on the surface of the membrane 110 or the modified membrane 402. In this manner, the contaminants are concentrated by the interfacial evaporation device. In some implementations, one or more sensors 114 (FIG. 1) can be deployed as part of (e.g., attached to) the interfacial evaporation device. The sensors 114 can monitor a water level in the pond. Alternatively or in addition, the sensors 114 can monitor an evaporation level of the interfacial evaporation device. The sensors 114 can transmit monitored values to a controller (not shown) from which the monitored values can be retrieved.

FIG. 7A is a schematic diagram of an example of a second implementation of a wick subassembly 700. FIGS. 7B, 7C and 7D are schematic diagrams of examples of respective interfacial evaporation devices implementing the wick subassembly 700. The wick sub-assembly 700 includes a first set of solid tubes 702 and a second set of solid tubes 704 that are collectively spatially arranged in a pattern that enhances operation of the evaporation pond.

In some implementations, each of the first set of solid tubes 702 is composed of a first material that is configured to enhance water evaporation. For example, the first material is hydrophilic, allowing each of the first set of solid tubes 702 to effectively absorb and transport water. In addition, the first material is oleophobic, which allows each of the first set of solid tubes 702 to resist oil contamination. Each of the second set of solid tubes 704 is made from a second material. The second material is configured to prevent water loss. For example, the second material is hydrophobic, allowing each of the second set of solid tubes 704 to provide a barrier that prevents water from escaping the evaporation pond.

Each of the first set of solid tubes 702 and each of the second set of solid tubes 704 can have a cylindrical cross-section, or it can be shaped with other cross-sectional profiles such as rectangular, square, triangular, or hexagonal. These alternative shapes may be selected depending on the desired fluid transport characteristics or mechanical stability.

FIG. 7A is also a top or bottom view of the floating member 108, which includes the first and second set of tubes connected as described here. In some implementations, the tubes can be spatially arranged in a pattern, e.g., an alternating pattern of a first tube 702 followed by a second tube 704 arranged in a geometric shape (e.g., a circle or a square), with a first tube 702 disposed at the center of the geometric shape. The pattern can be chosen following a study of evaporation performance of the interfacial evaporation device with the wick subassembly 700 arranged according to the pattern.

FIGS. 7B, 7C and 7D are schematic diagrams of examples of respective interfacial evaporation devices 100 (FIGS. 7B), 400 (FIGS. 7C, 7D) implementing the wick sub-assembly 700. FIG. 7B shows the interfacial evaporation device 102 including the member 108 that can float on a surface of the water 106 in the evaporation pond 100. The interfacial evaporation device 102 includes the membrane 110 disposed on the surface of the member 108.

In place of (or in addition to) the wick 112 (FIG. 1), the interfacial evaporation device 102 includes the wick subassembly 700 (FIG. 7A). Each end of each of the first set of solid tubes 702 and each end of each of the second set of solid tubes 704 is attached to the floating member 108. In particular, each end of each of the first set of solid tubes 702 goes through the floating member 108 and extends to and contacts, i.e., directly contacts, the membrane 110. In the context of this disclosure, “directly contacts” means a direct touching without an intermediary member or component. In contrast, each end of each of the second set of solid tubes 704 terminates within the floating member 108 and does not extend to or directly contact the membrane 110. Each other end of each of the first set of solid tubes 702 and each other end of each of the second set of solid tubes 704 is inserted into the water 106 such that each other end of each tube directly contacts the water. Because each first tube 702 is made of a hydrophilic material, the water is drawn towards the surface of the evaporation pond and to the membrane 100. Because each second tube 704 is hydrophobic and oleophilic, each second tube 704 not only enables water retention within the evaporation pond but also collects oil from the pond, thereby increasing oil recovery using the second set of tubes 704

FIG. 7C shows the interfacial evaporation device 400 in which the membrane 102 is replaced by the modified membrane 402. The remainder of the construction of the interfacial evaporation device 400, specifically the installation and deployment of the wick subassembly 700, is substantially identical to that of the interfacial evaporation device 102.

FIG. 7D shows the interfacial evaporation device 400 in which the membrane 102 is replaced by the modified membrane 402. The wick subassembly 700 is used in the implementation shown in FIG. 7D. The construction of the wick subassembly 700, however, is different from that shown in FIGS. 7B and 7C. In particular, the construction and arrangement of the first set of tubes 702 in the implementation shown in FIG. 7D is substantially identical to that shown in the implementations of FIGS. 7B and 7C. In the implementation shown in FIG. 7D, the second set of tubes 704 of the wick subassembly 700 are not connected to the floating member 108. Instead, one end of each second set of tubes 704 extends out of the evaporation pond to atmosphere above the water surface. The other end of each second set of tubes 704 is in direct contact with the water. In this arrangement, the first set of tubes 702 operate in the same manner for the implementations described in FIGS. 7B, 7C and 7D. Because each second tube 704 is oleophilic, the oil collected by each second tube 704 is carried directly above the surface of the water and can be collected.

Further, the surface area of the floating member 108 in the implementations shown in FIGS. 7B and 7C is greater than that in the implementation shown in FIG. 7D. The reduced surface area of the floating member 108 in the implementation shown in FIG. 7D allows the second tube 704 to extend above the surface of the water without contacting the floating member 704.

Furthermore, the implementation shown in FIG. 7C can be modified to allow the second tube 704 to extend through the floating member 108 and out of the evaporation pond without contacting the membrane 402. To do so, the second tube 704 can be passed in the space between the membrane 402 and the upper surface of the floating member 108.

In operation, the wick subassembly 700 contacts the water 106 in the evaporation pond schematically shown in FIGS. 7B, 7C or 7D. Due to the hydrophilic nature of each of the first set of tubes 702, the wick subassembly 700 draws the water 106 towards itself and directs the drawn water to the membrane through the member 108. At the same time, the hydrophobic nature of each of the second set of tubes 704 prevents water from escaping the evaporation pond. Each of the second set of tubes 704 further draws oil due to their oleophilic nature. The membrane absorbs the water from the first set of tubes 702. The absorbed water spreads to the exposed surface area of the membrane. As described above, the membrane also absorbs sunlight, converts the sunlight into thermal energy, and uses the thermal energy to evaporate the water absorbed by the membrane. The evaporated water leaves behind contaminants carried by the water on the surface of the membrane. In this manner, the contaminants are concentrated by the interfacial evaporation device. In some implementations, one or more sensors 114 (FIG. 1) can be deployed as part of (e.g., attached to) the interfacial evaporation device. The sensors 114 can monitor a water level in the pond. Alternatively or in addition, the sensors 114 can monitor an evaporation level of the interfacial evaporation device. The sensors 114 can transmit monitored values to a controller (not shown) from which the monitored values can be retrieved.

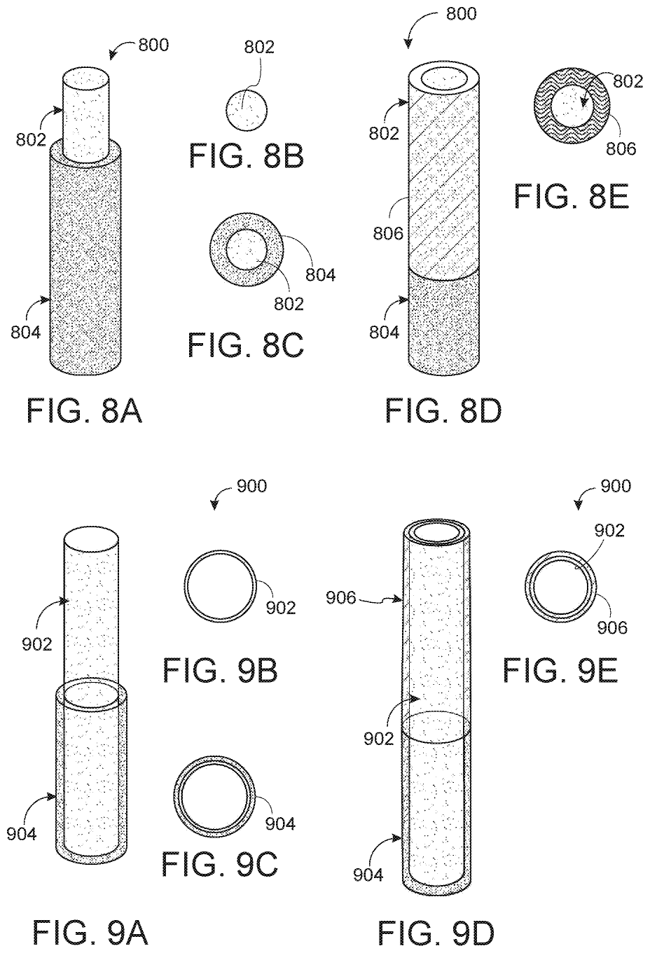

FIGS. 8A-8E are schematic diagrams of examples of a third implementation of a wick subassembly 800. The wick subassembly 800 can be deployed in an interfacial evaporation device in a manner similar to which the wick subassembly 600 is deployed as described above. The wick subassembly 800 includes a thread 802 made of a first material that is configured to enhance water evaporation. The thread 802 is solid unlike the hollow core in the hollow fiber configurations described earlier. The thread 802 can be a porous material that is hydrophilic or can be the material of construction of the whole thread (e.g., cotton, cellulose) coated or co-extruded. For example, the first material is hydrophilic, allowing the thread 802 to effectively absorb and transport water. In addition, the first material is oleophobic, which allows the thread 802 to resist oil contamination. The thread 802 includes a first portion and a second portion. For example, the thread 802 can have a construction similar to an elongate tube. An upper half of the elongate tube can define the first portion while the rest of the elongate tube can define the second portion.

The wick subassembly 800 includes a coating 804 covering the second portion but not the first portion of the thread 802. The coating 804 is made from a second material. The second material is configured to prevent water loss. For example, the second material is hydrophobic, allowing the coating 804 to provide a barrier that prevents water from escaping.

Together, the combination of the thread 802 with the coating 804 covering the first portion of the thread 802 can have a cylindrical cross-section as shown in FIGS. 8B and 8C, or it can be shaped with other cross-sectional profiles such as rectangular, square, triangular, or hexagonal. These alternative shapes may be selected depending on the desired fluid transport characteristics or mechanical stability.

FIG. 8D is a schematic diagram showing the first portion of the thread 802 coated with a photothermal coating 806. The photothermal coating 806 covers the first portion of the thread 802 but does not contact or cover the second portion of the thread 802. The axial cross-sections at the ends of the thread 802 are uncovered allowing the hydrophilic, oleophobic first material to directly contact the water in the evaporation pond on one end and the membrane (e.g., the membrane 100 or the modified membrane 402) on the other end. Like the combination of the thread 802 and the coating 804, the combination of the photothermal coating 806 covering the first portion of the thread 802 can also have a cylindrical cross-section or have other cross-sectional profiles (FIGS. 8D, 8E).

In operation, the wick subassembly 800 contacts the water in the evaporation pond. A circumferential end of the thread 802 is exposed to increase direct contact between the water in the evaporation pond and the wick subassembly 800. Due to the hydrophilic nature of the thread 802, the wick subassembly 800 draws the water towards itself and directs the drawn water to the membrane through the member. At the same time, the hydrophobic nature of the coating 804 prevents water from escaping the thread 802. The membrane absorbs the water from the wick subassembly 800. The absorbed water spreads to the exposed surface area of the membrane. As described above, the membrane also absorbs sunlight, converts the sunlight into thermal energy, and uses the thermal energy to evaporate the water absorbed by the membrane. The evaporated water leaves behind contaminants carried by the water on the surface of the membrane. In this manner, the contaminants are concentrated by the interfacial evaporation device. In some implementations, one or more sensors 114 (FIG. 1) can be deployed as part of (e.g., attached to) the interfacial evaporation device. The sensors 114 can monitor a water level in the pond. Alternatively or in addition, the sensors 114 can monitor an evaporation level of the interfacial evaporation device. The sensors 114 can transmit monitored values to a controller (not shown) from which the monitored values can be retrieved.

FIGS. 9A-9E are schematic diagrams of examples of a fourth implementation of a wick subassembly 900. The wick subassembly 900 can be deployed in an interfacial evaporation device in a manner similar to which the wick subassembly 600 or the wick sub-assembly 800 is deployed as described above. The wick subassembly 900 includes a hollow fiber 902 made of a first material that is configured to enhance water evaporation. For example, the first material is hydrophilic, allowing the hollow fiber 902 to effectively absorb and transport water. In addition, the first material is oleophobic, which allows the hollow fiber 902 to resist oil contamination. The hollow fiber 902 includes a first portion and a second portion. For example, the hollow fiber 902 can have a construction similar to an elongate tube. An upper half of the elongate tube can define the first portion while the rest of the elongate tube can define the second portion.

The wick subassembly 900 includes a shell 904 covering the second portion but not the first portion of the hollow fiber 902. The hollow fiber 904 is made from a second material. The second material is configured to prevent water loss. For example, the second material is hydrophobic, allowing the shell 904 to provide a barrier that prevents water from escaping.

Together, the combination of the hollow fiber 902 with the shell 904 covering the first portion of the hollow fiber 902 can have a cylindrical cross-section as shown in FIGS. 9B and 9C, or it can be shaped with other cross-sectional profiles such as rectangular, square, triangular, or hexagonal. These alternative shapes may be selected depending on the desired fluid transport characteristics or mechanical stability.

FIG. 9D is a schematic diagram showing the first portion of the hollow fiber 902 coated with a photothermal coating 906. The photothermal coating 906 covers the first portion of the hollow fiber 902 but does not contact or cover the second portion of the hollow fiber 902. The axial cross-sections at the ends of the hollow fiber 902 are uncovered allowing the hydrophilic, oleophobic first material to directly contact the water in the evaporation pond on one end and the membrane (e.g., the membrane 100 or the modified membrane 402) on the other end. In addition, because the fiber 902 is hollow, water can enter an inner volume of the fiber 902 and be exposed to the inner wall of the fiber 902. In this manner, the hollow nature of the fiber 902 can increase an amount of surface area available to absorb water from the evaporation pond. Like the combination of the hollow fiber 902 and the shell 904, the combination of the photothermal coating 906 covering the first portion of the hollow fiber 902 can also have a cylindrical cross-section or have other cross-sectional profiles (FIGS. 9D, 9E).

In operation, the wick subassembly 900 contacts the water in the evaporation pond. An axial end of the hollow fiber 902 is exposed to increase direct contact between the water in the evaporation pond and the wick subassembly 900. Additionally, water enters the hollow internal volume of the fiber 902. Due to the hydrophilic nature of the hollow fiber 902, the wick subassembly 900 draws the water towards itself and directs the drawn water to the membrane through the member. The shell 904 covers the circumferential portion, i.e., the second portion, while the first portion of the hollow fiber 902 remains exposed. At the same time, the hydrophobic nature of the shell 904 prevents water from escaping the hollow fiber 902. The membrane absorbs the water from the wick subassembly 800. The absorbed water spreads to the exposed surface area of the membrane. As described above, the membrane also absorbs sunlight, converts the sunlight into thermal energy, and uses the thermal energy to evaporate the water absorbed by the membrane. The evaporated water leaves behind contaminants carried by the water on the surface of the membrane. In this manner, the contaminants are concentrated by the interfacial evaporation device. In some implementations, one or more sensors 114 (FIG. 1) can be deployed as part of (e.g., attached to) the interfacial evaporation device. The sensors 114 can monitor a water level in the pond. Alternatively or in addition, the sensors 114 can monitor an evaporation level of the interfacial evaporation device. The sensors 114 can transmit monitored values to a controller (not shown) from which the monitored values can be retrieved.

Any implementation of the interfacial evaporation device described here can be integrated with other floating devices such as solar panels or wind turbines to drive evaporation. For example, in place of mechanical evaporators that use moving parts and require energy to be driven, the interfacial evaporation device described here can passively drive evaporation with minimal or no energy consumption. Further, a feature described with reference to the wick 112 or any wick subassembly can be combined with one or more other features described with reference to the wick 112 or any other wick subassembly.

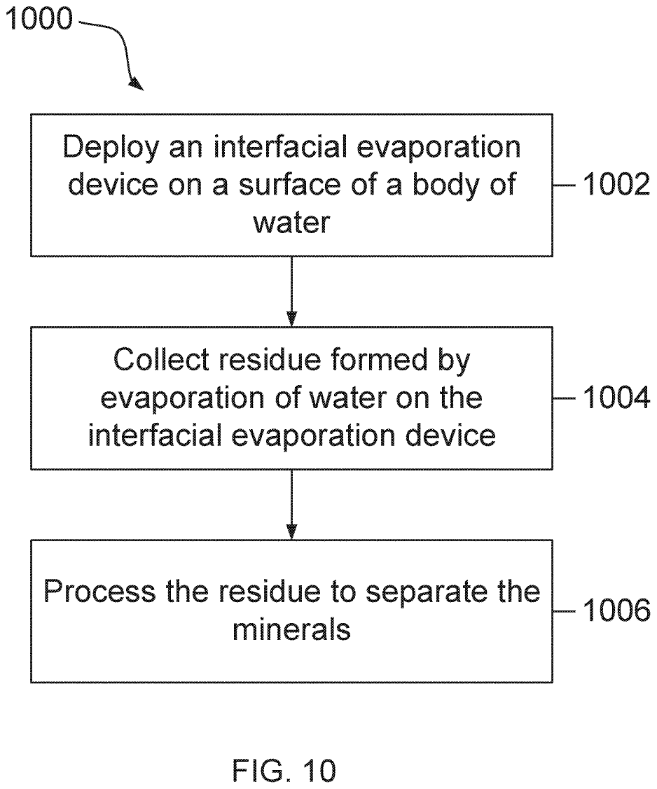

FIG. 10 is a flowchart of an example of a process 1000 of recovering minerals. At 1002, an interfacial evaporation device is deployed on a surface of a body of water. For example, the interfacial evaporation device can be the device 100 described in various implementations in this disclosure. The process 1000 can alternatively or additionally be implemented using other evaporation devices that can be deployed on the surface of an evaporation pond and that operate by drawing water from the pond to the surface where the water dries leaving solid residue including minerals.

As described in this disclosure, the interfacial evaporation device is configured to draw water to its surface. The drawn water is evaporated by solar energy on the exposed surface of the interfacial evaporation device. After evaporation, a residue that includes minerals is deposited on the surface of the interfacial evaporation device. The minerals include, for example, sodium chloride, calcium carbonate and calcium sulfate. At 1004, the residue is collected from the surface of the interfacial evaporation device. At 1006, the collected residue is processed to separate the minerals.

To collect the residue from the surface of the interfacial evaporation device, the interfacial evaporation device can be retrieved from the evaporation pond. The residue can be scraped from its surface using, for example, a scraper or similar tool. The residue can also be separated using techniques known to separate and purify mixed metal salts such as siccative precipitation, ion exchange, solvent extraction, to name a few.

As mentioned earlier, the collected residue is processed to separate the minerals. To do so, the residue is mixed with fluid in a container. For example, the fluid can include deionized water or warm water. A portion of the minerals dissolve in the fluid and a remainder of the minerals are undissolved. The mixed fluid is filtered using a filter in a filtration flask to separate the dissolved minerals from the undissolved minerals. For example, the filter can include filter paper with a sieve size of about 0.45 micrometers (μm).

The filtration separates the undissolved minerals separated from the fluid with the dissolved minerals. The undissolved minerals can then be dried. The dissolved minerals can be recovered by drying or evaporation of the fluid with the dissolved minerals.

### EXAMPLES

Certain aspects of the subject matter described here can be implemented as a device for interfacial water evaporation of a body of water. The device includes a floating hydrophobic member configured to float at a surface of the body of water. A membrane is disposed on a surface of the floating hydrophobic member. The membrane defines an evaporation surface of the device for receiving solar energy. A wick subassembly is connected to the membrane and extends through the floating hydrophobic member. The wick subassembly includes a first material configured to enhance evaporation and a second material configured to prevent water loss. The wick subassembly is configured to extend into the body of water and draw water from the body of water and direct the drawn water to the membrane. The membrane is configured to transfer at least a portion of the received solar energy to the drawn water directed to the membrane to evaporate the drawn water, thereby decreasing a water content of the body of water.

An aspect combinable with any other aspect includes the following features. The first material is hydrophilic.

An aspect combinable with any other aspect includes the following features. The first material is oleophobic.

An aspect combinable with any other aspect includes the following features. The second material is hydrophobic.

An aspect combinable with any other aspect includes the following features. The wick subassembly includes a core member made of the first material, and an outer shell surrounding the core member. The outer shell is made of the second material.

An aspect combinable with any other aspect includes the following features. The outer shell is non-porous.

An aspect combinable with any other aspect includes the following features. The core member is in direct contact with the membrane.

An aspect combinable with any other aspect includes the following features. The wick subassembly includes a first set of multiple wicks and a second set of multiple wicks. Each of the first set of multiple wicks is attached to the floating member at a first end and contacts the water at a second end. The first set of multiple wicks are made of the first material. Each of the second set of multiple wicks is attached to the floating member at a first end and contacts the water at a second end. The second set of multiple wicks are made of the second material. The first set of multiple wicks are spatially separated from the second set of multiple wicks.

An aspect combinable with any other aspect includes the following features. The first end of each of the first set of multiple wicks is in direct contact with the membrane.

An aspect combinable with any other aspect includes the following features. The first end of each of the second set of multiple wicks is separated from the membrane.

An aspect combinable with any other aspect includes the following features. The wick subassembly includes a thread made of the first material. The thread includes a first portion and a second portion. The wick subassembly includes a coating made of the second material. The coating covers the second portion but not the first portion of the thread.

An aspect combinable with any other aspect includes the following features. The first portion of the thread is in direct contact with the membrane.

An aspect combinable with any other aspect includes the following features. The coating and the second portion of the thread are in direct contact with the water.

An aspect combinable with any other aspect includes the following features. The device includes photothermal material coating the first portion of the thread.

An aspect combinable with any other aspect includes the following features. The wick subassembly includes a hollow fiber made of the first material. The hollow fiber includes a first portion and a second portion. The wick subassembly includes a shell made of the second material. The shell covers the second portion but not the first portion of the hollow fiber.

An aspect combinable with any other aspect includes the following features. The first portion of the hollow fiber is in direct contact with the membrane.

An aspect combinable with any other aspect includes the following features. The shell and the second portion of the hollow fiber are in direct contact with the water.

An aspect combinable with any other aspect includes the following features. The device includes a photothermal material coating the first portion of the hollow fiber.

An aspect combinable with any other aspect includes the following features. The membrane includes a planar membrane directly contacting a portion of the wick sub-assembly including the first material.

An aspect combinable with any other aspect includes the following features. The membrane includes multiple tubes. Each tube has a first end directly contacting a portion of the wick subassembly including the second material.

Certain aspects of the subject matter described here can be implemented as a method of recovering minerals. An interfacial evaporation device is deployed on a surface of a body of water. The interfacial evaporation device is configured to draw water to a surface of the interfacial evaporation device. The drawn water is evaporated by solar energy depositing a residue including minerals on the surface of the interfacial evaporation device. The residue is collected from the surface of the interfacial evaporation device. The collected residue is processed to separate the minerals.

An aspect combinable with any other aspect includes the following features. The minerals include sodium chloride, calcium carbonate and calcium sulfate.

An aspect combinable with any other aspect includes the following features. To collect the residue from the surface of the interfacial evaporation device, the interfacial evaporation device is retrieved from the surface of the body of water. The residue is scraped from the surface of the interfacial evaporation device.

An aspect combinable with any other aspect includes the following features. To process the collected residue to separate the minerals, the residue is mixed with a fluid in a container. A portion of the minerals dissolve in the fluid. A remainder of the minerals are undissolved. The mixed fluid is filtered using a filter in a filtration flask to separate the dissolved minerals from the undissolved minerals.

An aspect combinable with any other aspect includes the following features. The fluid with which the residue is mixed id deionized water or warm water.

An aspect combinable with any other aspect includes the following features. The filter in the filtration flask includes filter paper with a sieve size of 0.45 micrometers (μm).

An aspect combinable with any other aspect includes the following features. The undissolved minerals are separated from the fluid with the dissolved minerals. The undissolved minerals are dried.

An aspect combinable with any other aspect includes the following features. The dissolved minerals are recovered by drying or evaporation of the fluid with the dissolved minerals.

An aspect combinable with any other aspect includes the following features. The separated minerals are used in well operations including wellbore drilling. The separated minerals are used as additives to wellbore drilling fluids.

Thus, particular implementations of the subject matter have been described. Other implementations are within the scope of the following claims.

1. A method of recovering minerals, the method comprising:
deploying an interfacial evaporation device on a surface of a body of water, the interfacial evaporation device configured to draw water to a surface of the interfacial evaporation device, wherein the drawn water is evaporated by solar energy depositing a residue comprising minerals on the surface of the interfacial evaporation device;
collecting the residue from the surface of the interfacial evaporation device; and
processing the collected residue to separate the minerals.

2. The method of claim 1, wherein the minerals comprise sodium chloride, calcium carbonate and calcium sulfate.

3. The method of claim 1, wherein collecting the residue from the surface of the interfacial evaporation device comprises:
retrieving the interfacial evaporation device from the surface of the body of water; and
scraping the residue from the surface of the interfacial evaporation device.

4. The method of claim 1, wherein processing the collected residue to separate the minerals comprises:
mixing the residue with a fluid in a container, wherein a portion of the minerals dissolve in the fluid and a remainder of the minerals are undissolved; and
filtering the mixed fluid using a filter in a filtration flask to separate the dissolved minerals from the undissolved minerals.

5. The method of claim 4, wherein the fluid with which the residue is mixed is deionized water.

6. The method of claim 4, wherein the filter in the filtration flask comprises filter paper with a sieve size of 0.45 micrometers (μm).

7. The method of claim 4, further comprising:
separating the undissolved minerals from the fluid with the dissolved minerals; and
drying the undissolved minerals.

8. The method of claim 5, further comprising recovering the dissolved minerals by drying or evaporation of the fluid with the dissolved minerals.

9. The method of claim 1, further comprising using the separated minerals in well operations comprising wellbore drilling, wherein the separated minerals are used as additives to wellbore drilling fluids.

10. The method of claim 1, wherein the interfacial evaporation device comprises:
a floating hydrophobic member configured to float at a surface of the body of water;
a membrane disposed on a surface of the floating hydrophobic member, wherein the membrane defines an evaporation surface of the device for receiving the solar energy; and
a wick subassembly connected to the membrane and extending through the floating hydrophobic member.

11. The method of claim 10, wherein the wick subassembly comprises:
a first material configured to enhance water evaporation, and
a second material configured to prevent water loss,
wherein the wick subassembly is configured to extend into the body of water and draw water from the body of water and direct the drawn water to the membrane, wherein the membrane is configured to transfer at least a portion of the received solar energy to the drawn water directed to the membrane to evaporate the drawn water, thereby decreasing a water content of the body of water.

12. The method of claim 1, wherein the first material is hydrophilic.

13. The method of claim 12, wherein the first material is oleophobic.

14. The method of claim 10, wherein the second material is hydrophobic.

15. The method of claim 10, wherein the wick subassembly comprises:
a core member made of the first material; and
an outer shell surrounding the core member, the outer shell made of the second material.

16. The method of claim 15, wherein the outer shell is non-porous.

17. The method of claim 15, wherein the core member is in direct contact with the membrane.

18. The method of claim 10, wherein the wick subassembly comprises:
a first plurality of wicks, each attached to the floating member at a first end and contacting the water at a second end, wherein the first plurality of wicks are made of the first material; and
a second plurality of wicks, each attached to the floating member at a first end and contacting the water at a second end, wherein the second plurality of wicks are made of the second material, wherein the first plurality of wicks are spatially separated from the second plurality of wicks.

19. The method of claim 18, wherein the first end of each of the first plurality of wicks is in direct contact with the membrane.

20. The method of claim 19, wherein the first end of each of the second plurality of wicks is separated from the membrane.
